(19) United States
(12) Patent Application Publication
(10) Pub. No.: US 2019/0323410 A1
(43) Pub. Date: Oct. 24, 2019

(54) SELF-ALIGNING MOUNT

(71) Applicant: GM GLOBAL TECHNOLOGY OPERATIONS LLC, Detroit, MI (US)

(72) Inventors: David A. Holmes, Howell, MI (US); Richard L. Johnson, Dryden, MI (US)

(21) Appl. No.: 15/956,224

(22) Filed: Apr. 18, 2018

(51) Int. Cl. F01N 13/18; B60K 13/04

(52) U.S. Cl. CPC F01N 13/1855; B60K 13/04; F01N 13/1822

(57) ABSTRACT

A close coupled exhaust system support assembly comprises a mounting bracket coupled to an internal combustion engine having an extension including a through-hole. A support tab is fixedly attached to the exhaust system and has a terminal end located adjacent to the mounting bracket extension. A through-hole in the support tab is aligned with the through-hole of the mounting bracket extension. A mounting apparatus comprises a ferrule, having a through-hole extending therethrough and a spherical outer surface that is disposed within the through-hole of the support tab. The through-hole of the ferrule and the through-hole of mounting bracket extension define an axially extending receiving passage. A fastener disposed in the axially extending receiving passage fixes the mounting bracket extension relative to the support tab with an axial force exerted on the ferrule that deforms the spherical outer surface of the ferrule against the walls of the support tab through-hole.

### INTRODUCTION

The subject disclosure relates to the mounting of misaligned vehicular components and, more particularly, to a mounting system having features for reliably connecting misaligned exhaust system components.

Exhaust systems and related exhaust treatment devices may be used in motor vehicles having an internal combustion engine to conduct exhaust away from the engine while reducing regulated constituents of the exhaust gas. Such exhaust system typically comprise numerous individual components that are assembled together into a final system which is attached, at numerous locations, to a vehicle. A close coupled exhaust treatment device, such as a catalytic converter, may be used with some internal combustion engines to convert hydrocarbons (“HC”) and carbon monoxide (“CO”) to carbon dioxide (“CO2”) and water vapor.

While the addition of a close couple exhaust treatment device provides solutions to certain exhaust emission requirements, the appending of components to an engine may create certain design and packaging challenges. Some engine configurations are not well suited to the placement and support of a close coupled exhaust treatment device, as there is often little space to locate a support bracket for the device. In addition, exhaust systems typically comprise multiple assemblies and sub-assemblies that are welded, or otherwise attached to one another; providing for tolerance stack-up and the potential for variation at mounting bracket interfaces. When variations do occur, over-constraint of the exhaust system to the mounting bracket, or other vehicle components, may lead to stresses on the system such as cracking of component parts and exhaust gas leakage, vibration, noise and/or other negative characteristics.

Accordingly, a system and method for providing a stable and versatile mounting of an exhaust system, and in particular a close mounted exhaust treatment device, to an internal combustion engine is desirable.

### SUMMARY

In one exemplary embodiment a close coupled exhaust system support assembly for an internal combustion engine comprises a wall portion of the internal combustion engine and an exhaust system located adjacent to the wall portion. A mounting bracket comprises a first extension coupled to the wall portion and a second extension projecting outwardly from the wall portion and including a through-hole therein. A support tab is fixedly attached at a proximal end to, and extends outwardly from, the exhaust system and has first opposed faces and a terminal end located adjacent to the second extension of the mounting bracket. A through-hole in the support tab is aligned with the through-hole of the second extension of the mounting bracket. A mounting apparatus comprises a ferrule, having a through-hole extending therethrough and a spherical outer surface, disposed within the through-hole of the support tab. The ferrule through-hole is aligned with the through-hole of the second extension of the mounting bracket to define an axially extending receiving passage. End flats, disposed on axially opposite ends of the ferrule, extend axially beyond the opposed surfaces of the support tab and a fastener is disposed in the axially extending receiving passage to fix the second extension of the mounting bracket relative to the support tab with an axial force exerted on the ferrule flats that deforms the curved outer surface of the ferrule against the walls of the support tab through-hole.

In addition to one or more of the features described herein, the fastener comprises a threaded fastener, such as a bolt and a nut, wherein tightening the nut on the bolt causes the bolt head, disposed against the second extension of the mounting bracket, to fix the second extension relative to the support tab.

In addition to one or more of the features described herein, a channel portion is located in the wall of the ferrule through-hole to narrow the ferrule wall thickness and promote flexibility of the ferrule when under the axial force exerted by the fastener.

In addition to one or more of the features described herein, a sleeve member is disposed in the ferrule through-hole, between the ferrule and the fastener, to increase outward deformation of a center portion of the ferrule against the walls of the support tab through-hole and to minimize inward deformation of outer portions of the ferrule against the fastener.

In another exemplary embodiment, close coupled exhaust system support assembly for an exhaust system located adjacent to an internal combustion engine, comprises a mounting bracket, coupled to the internal combustion engine, having an extension projecting outwardly therefrom and including a through-hole therein. A support tab is fixedly attached at a proximal end to, and extends outwardly from, the exhaust system and has first opposed faces and a terminal end located adjacent to the mounting bracket extension. A through-hole in the support tab is aligned with the through-hole of the mounting bracket extension. A mounting apparatus comprises a ferrule, having a through-hole extending therethrough and a spherical outer surface, disposed within the support tab through-hole such that the ferrule through-hole is aligned with the through-hole of the mounting bracket extension to define an axially extending receiving passage. End flats, disposed on axially opposite ends of the ferrule, extend axially beyond the opposed surfaces of the support tab. A fastener disposed in the axially extending receiving passage fixes the mounting bracket extension relative to the support tab with an axial force exerted on the ferrule flats that deforms the spherical outer surface of the ferrule against the walls of the support tab through-hole.

In addition to one or more of the features described herein the fastener comprises a threaded fastener, such as a bolt and a nut, wherein tightening the nut on the bolt causes the bolt head, disposed against the mounting bracket extension to fix the extension relative to the support tab.

In addition to one or more of the features described herein a channel portion is located in the wall of the ferrule through-hole to narrow the ferrule wall thickness and promote flexibility of the ferrule when under the axial force exerted by the fastener.

In addition to one or more of the features described herein a sleeve member is disposed in the ferrule through-hole, between the ferrule and the bolt, to increase outward deformation of a center portion of the ferrule against the walls of the support tab through-hole and to minimize inward deformation of the outer portions of the ferrule against the fastener.

In yet another embodiment, a close coupled exhaust system support assembly comprises a mounting bracket coupleable to an internal combustion engine having an extension including a through-hole. A support tab is fixedly attached to the exhaust system and has a terminal end located adjacent to the mounting bracket extension and a through-hole aligned with the through-hole of the mounting bracket extension. A mounting apparatus comprises a ferrule, having a through-hole extending therethrough and a spherical outer surface, disposed within the support tab through-hole such that the ferrule through-hole and the through-hole of mounting bracket extension define an axially extending receiving passage. A fastener disposed in the axially extending receiving passage fixes the mounting bracket extension relative to the support tab by exerting an axial force on the ferrule that deforms the spherical outer surface of the ferrule against the walls of the support tab through-hole.

In addition to one or more of the features described herein further a channel portion is located in the wall of the ferrule through-hole to narrow the ferrule thickness and to promote flexibility of the ferrule when under the axial force exerted by the fastener.

In addition to one or more of the features described herein further a sleeve member is disposed in the ferrule through-hole, between the ferrule and the fastener, to increase outward deformation of a center portion of the ferrule against the walls of the support tab through-hole and to minimize inward deformation of the outer portions of the ferrule against the fastener.

The above features and advantages, and other features and advantages of the disclosure are readily apparent from the following detailed description when taken in connections with the accompanying drawings.

### BRIEF DESCRIPTION OF THE DRAWINGS

Other features, advantages and details appear, by way of example only, in the following detailed description, the detailed description referring to the drawings in which:

FIG. 1 is a view of an exhaust treatment device, a mounting system, and an engine block according to one or more embodiments;

FIG. 2 is an enlarged view of a portion of FIG. 1;

FIG. 3 is a sectional view taken along line 3-3 of FIG. 2; and

FIGS. 4A, 4B and 4C are sectional views taken along line 4-4 of FIG. 3, according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

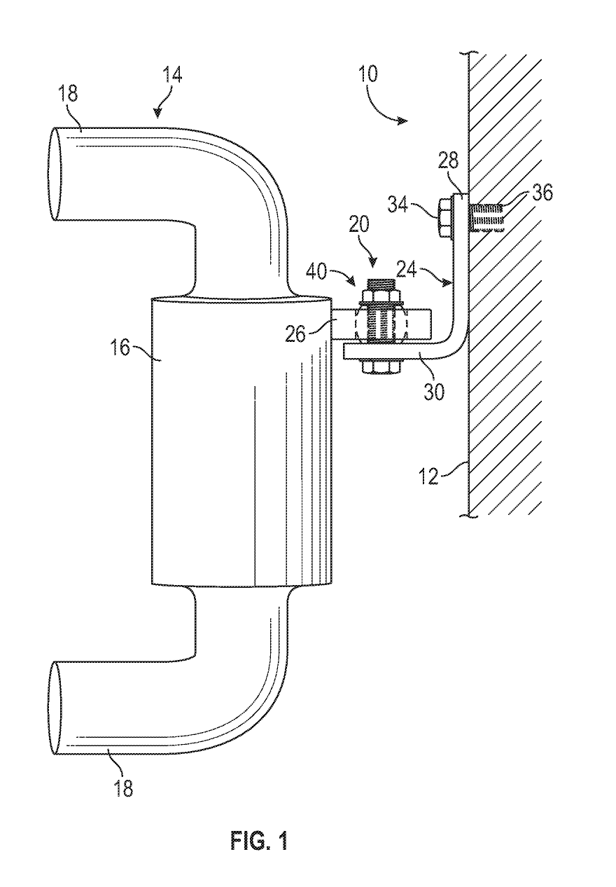

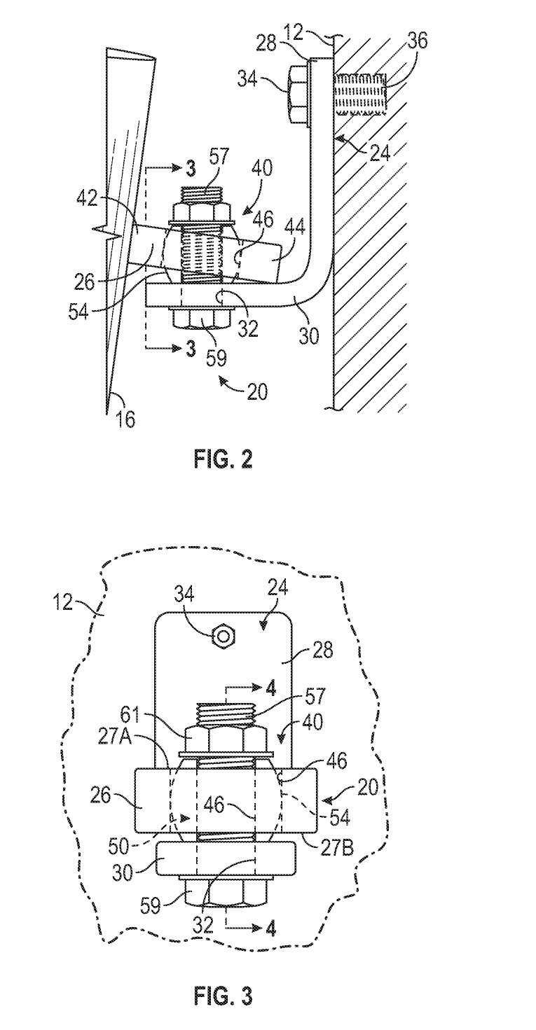

Referring to FIGS. 1, 2 and 3, a wall portion 12 of an internal combustion engine (IC engine) 10 is illustrated. The wall portion 12 may be a side wall of an engine block or other rigid surface of the IC engine or other vehicle component, as an example. An exhaust system 14 is disposed adjacent to the wall portion 12 of the IC engine 10 and conducts exhaust gas from engine combustion chambers (not illustrated) through one or more exhaust treatment devices 16 via exhaust gas conduits 18. Following the treatment of regulated exhaust constituents of the exhaust gas, by the one or more exhaust treatment devices 16, the exhaust gas is released to the atmosphere. A close-coupled exhaust system support assembly (support assembly) 20 extends between, and is attached to, the wall portion 12 of the IC engine 10 and the exhaust system 14. The support assembly 20 supports the exhaust system 14 in a close-coupled relationship with the IC engine 10 and includes a mounting bracket 24 and support tab 26.

In the embodiment illustrated, the mounting bracket is an L-shaped piece having a first extension 28 coupled to the wall portion 12 of the IC engine 10, or other rigid vehicle component. The mounting bracket 24 is constructed of a durable material such as stainless steel, iron or high temperature composite, for instance. Coupling of the first extension 28 of the mounting bracket 24 to the wall portion 12 may be through any suitable fastening means such as the bolt 34 that is received in a threaded opening 36 in the wall portion 12. The first extension may also be bonded or welded to the wall portion 12 of the IC engine 10. A second extension 30 of the mounting bracket 24 projects outwardly from the wall portion 12 and includes a through-hole 32 configured to receive mounting apparatus 40, described herein.

In an embodiment, the support tab 26 is also constructed of a durable material such as stainless steel or iron and is fixedly attached to the exhaust system 14 via welding at a proximal end 42, for instance. The support tab extends outwardly from the exhaust system 14 having opposed faces 27A and 27B and a terminal end 44 that is located adjacent to the second extension 30 of the mounting bracket 24. A through-hole 46 aligns with the through-hole 32 of the second extension 30 of the mounting bracket 24 and is configured to receive a portion of the mounting apparatus 40, described herein.

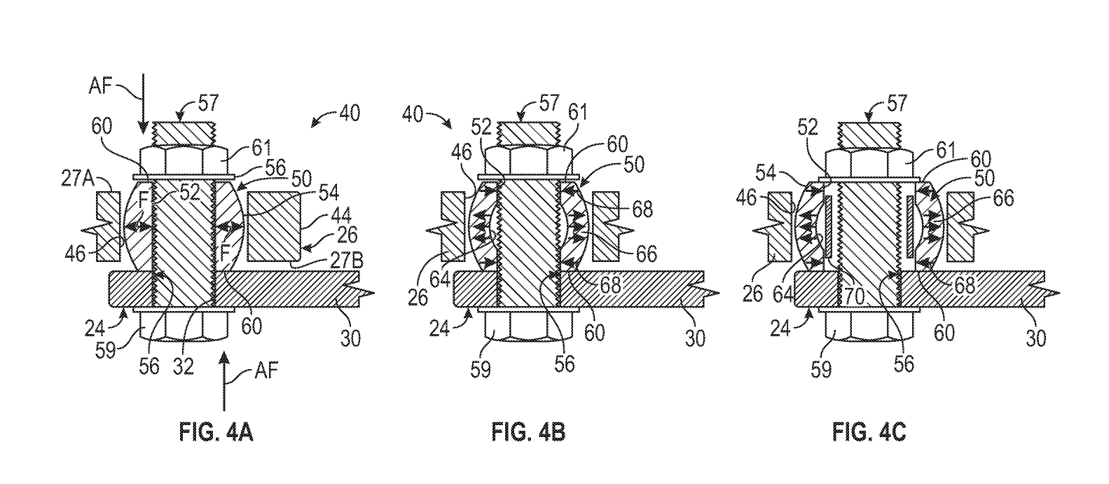

Referring to FIG. 4A, with continuing reference to FIGS. 1-3, in an embodiment, the mounting apparatus 40 comprises a ferrule 50, having a through-hole 52 extending therethrough and a curved (spherical) outer surface 54, that is disposed within the through-hole 46 of the support tab 26. When the ferrule 50 is installed in the through-hole 46, the through-hole 52 of the ferrule 50 aligns with the through-hole 32 of second extension 30 of mounting bracket 24 to define an axially extending receiving passage 56. End flats 60, disposed on axially opposite ends of the ferrule 50 extend axially beyond the opposed surfaces 27 A and 27B of the support tab 26. A fastener, such as a bolt 57, is disposed in and extends through the axially extending receiving passage 56. The bolt 57 is fixed in place using a nut 61. Tightening the nut 61 on the bolt 56 causes the bolt head 59, disposed against the second extension 30 of the mounting bracket 24, to fix the second extension 30 relative to the support tab 26. Axial force “AF” exerted by the bolt 57 on the ferrule flats 60 deform the curved outer surface 54 of the ferrule 50 against the walls of the through-hole 46 of the support tab 26 thereby fixing the ferrule tightly therein through the exertion of deformation forces “F”. The mounting apparatus 40 compensates for mis-alignment between the second extension 30 of the mounting bracket 24 and the support tab 26 and prevents localized stress in the support assembly 20 that can lead to component failure.

Referring to FIG. 4B, in another embodiment of the disclosure, ferrule 50 includes an undercut or channel portion 64 located in the wall of the through-hole 52. The channel portion 64 operates to narrow the ferrule wall thickness and promote flexibility of the ferrule 50 when under compression during tightening of the nut 61 on the bolt 57. Deformation of the ferrule 50, during compression, is controlled in a manner that increases outward deformation of a center portion 66 against the walls of the through-hole 46 of the support tab 26 and invites inward deformation of the outer portions 68 of the ferrule 50 against the bolt 57 for increased rigidity of the overall mounting apparatus 40 once the nut 61 and bolt 57 are fully tightened.

Referring to FIG. 4C, in another embodiment of the disclosure, ferrule 50 includes an undercut or channel portion 64 located in the wall of the through-hole 52. The channel portion 64 operates to narrow the ferrule wall thickness and promote flexibility of the ferrule 50 when under compression during tightening of the nut 61 on the bolt 57. A cylindrical sleeve member 70 is disposed in the through-hole 52 of the ferrule 50, between the ferrule 50 and the bolt 57. Deformation of the ferrule 50, during compression, is controlled in a manner that increases outward deformation of a center portion 66 against the walls of the through-hole 46 of the support tab 26 while inward deformation of the outer portions 68 of the ferrule 50 against the bolt 57 is minimized by the sleeve member 70. The installation of the sleeve member 70 prevents collapse of the ferrule 50 under compression by the bolt 57 and nut 61 when a large diameter through-hole 46 is present in the support tab 26.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A close coupled exhaust system support assembly for an internal combustion engine, comprising:
a wall portion of the internal combustion engine;
an exhaust system located adjacent to the wall portion;
a mounting bracket comprising a first extension coupled to the wall portion and a second extension projecting outwardly from the wall portion and including a through-hole therein;
a support tab fixedly attached at a proximal end to, and extending outwardly from, the exhaust system and having first opposed faces and a terminal end located adjacent to the second extension of the mounting bracket;
a through-hole in the support tab aligned with the through-hole of the second extension of the mounting bracket; and
a mounting apparatus comprising:
a ferrule, having a through-hole extending therethrough and a spherical outer surface, disposed within the through-hole of the support tab, the ferrule through-hole aligned with the through-hole of second extension of the mounting bracket to define an axially extending receiving passage;
end flats, disposed on axially opposite ends of the ferrule, extending axially beyond the opposed surfaces of the support tab; and
a fastener disposed in the axially extending receiving passage to fix the second extension of the mounting bracket relative to the support tab with an axial force exerted on the ferrule flats that deforms the curved outer surface of the ferrule against the walls of the support tab through-hole.

2. The close coupled exhaust system support assembly of claim 1, wherein the fastener comprises a threaded fastener, such as a bolt and a nut, wherein tightening the nut on the bolt causes the bolt head, disposed against the second extension of the mounting bracket, to fix the second extension relative to the support tab.

3. The close coupled exhaust system support assembly of claim 1, further comprising a channel portion located in the wall of the ferrule through-hole to narrow the ferrule wall thickness and promote flexibility of the ferrule when under the axial force exerted by the fastener.

4. The close coupled exhaust system support assembly of claim 3, further comprising a sleeve member disposed in the ferrule through-hole, between the ferrule and the fastener, to increase outward deformation of a center portion of the ferrule against the walls of the support tab through-hole and to minimize inward deformation of outer portions of the ferrule against the fastener.

5. A close coupled exhaust system support assembly for an exhaust system located adjacent to an internal combustion engine, comprising:
a mounting bracket, coupled to the internal combustion engine, having an extension projecting outwardly therefrom and including a through-hole therein;
a support tab fixedly attached at a proximal end to, and extending outwardly from, the exhaust system and having first opposed faces and a terminal end located adjacent to the mounting bracket extension;
a through-hole in the support tab aligned with the through-hole of the mounting bracket extension; and
a mounting apparatus comprising:
a ferrule, having a through-hole extending therethrough and a spherical outer surface, disposed within the support tab through-hole such that the ferrule through-hole is aligned with the through-hole of the mounting bracket extension to define an axially extending receiving passage;
end flats, disposed on axially opposite ends of the ferrule, extending axially beyond the opposed surfaces of the support tab; and
a fastener disposed in the axially extending receiving passage to fix the mounting bracket extension relative to the support tab with an axial force exerted on the ferrule flats that deforms the spherical outer surface of the ferrule against the walls of the support tab through-hole.

6. The close coupled exhaust system support assembly of claim 5, wherein the fastener comprises a threaded fastener, such as a bolt and a nut, wherein tightening the nut on the bolt causes the bolt head, disposed against the mounting bracket extension to fix the extension relative to the support tab.

7. The close coupled exhaust system support assembly of claim 5, further comprising a channel portion located in the wall of the ferrule through-hole to narrow the ferrule wall thickness and promote flexibility of the ferrule when under the axial force exerted by the fastener.

8. The close coupled exhaust system support assembly of claim 7, further comprising a sleeve member disposed in the ferrule through-hole, between the ferrule and the bolt, to increase outward deformation of a center portion of the ferrule against the walls of the support tab through-hole and to minimize inward deformation of the outer portions of the ferrule against the fastener.

9. A close coupled exhaust system support assembly comprises:
a mounting bracket coupleable to an internal combustion engine having an extension including a through-hole;
a support tab fixedly attached to the exhaust system and having a terminal end located adjacent to the mounting bracket extension and a through-hole aligned with the through-hole of the mounting bracket extension;
a mounting apparatus comprising:
a ferrule, having a through-hole extending therethrough and a spherical outer surface, disposed within the support tab through-hole such that the ferrule through-hole and the through-hole of mounting bracket extension define an axially extending receiving passage; and
a fastener disposed in the axially extending receiving passage to fix the mounting bracket extension relative to the support tab by exerting an axial force on the ferrule that deforms the spherical outer surface of the ferrule against the walls of the support tab through-hole.

10. The close coupled exhaust system support assembly of claim 9, further comprising a channel portion located in the wall of the ferrule through-hole to narrow the ferrule thickness and promote flexibility of the ferrule when under the axial force exerted by the fastener.

11. The close coupled exhaust system support assembly of claim 10, further comprising a sleeve member disposed in the ferrule through-hole, between the ferrule and the fastener, to increase outward deformation of a center portion of the ferrule against the walls of the support tab through-hole and to minimize inward deformation of the outer portions of the ferrule against the fastener.
